(19) United States
(12) Patent Application Publication
(10) Pub. No.: US 2017/0000182 A1
(43) Pub. Date: Jan. 5, 2017

(54) NUTRITIONAL COMPOSITIONS WITH PHOSPHOLIPIDS

(71) Applicant: NESTEC S.A., Vevey (CH)

(72) Inventors: Karl-Josef Huber-Haag, Pully (CH); Catherine Mace, Lausanne (CH); Phillippe Steenhout, La Tour-de-Peilz (CH); Lien-Ahn Tran, Vevey (CH)

(21) Appl. No.: 15/100,049

(22) PCT Filed: Nov. 29, 2013
(86) PCT No.: PCT/EP2013/075054

§ 371 Date: May 27, 2016

(51) Int. Cl. A23L 33/19; A23L 33/00; A23L 33/18

(52) U.S. Cl. CPC A23L 33/19; A23L 33/18; A23L 33/40; A23V 2002/00

(57) ABSTRACT

The present invention relates to a nutritional composition such as an infant formula comprising phospholipids in an amount of at least 300 mg/L. Bioactive compounds may preferably be added to the nutritional composition. The present invention also relates to use of said nutritional composition by feeding an infant with the nutritional composition for reducing the risk of developing metabolic syndrome, increased weight gain, increased fat deposition, overweight, obesity, insulin resistance, glucose intolerance or diabetes mellitus later in said infant's life.

### TECHNICAL FIELD OF THE INVENTION

The present invention relates to a nutritional composition comprising phospholipids, and more specifically to an infant formula comprising phospholipids. Furthermore, the present invention relates to the use of said nutritional composition for reducing the risk of an infant fed with said nutritional composition to develop metabolic syndrome, overweight, obesity, glucose intolerance or diabetes mellitus later in life.

### BACKGROUND OF THE INVENTION

Mother's milk is recommended for all infants up to the age of 4-6 months. However, in some cases breast feeding is inadequate or unsuccessful or inadvisable for medical reasons, or the mother chooses not to breast feed either at all or for a period of more than a few weeks. Infant formulas have been developed for these situations.

Infants fed with infant formula are however known to have a higher growth rate than breast fed infants and to have higher postprandial plasma concentrations of insulin than breastfed infants. Today, no infant formulas are known which are capable of mimicking the postprandial response of plasma insulin in breastfed infant. For instance at 4 months of age, a formula fed infant may in certain instances have a plasma insulin concentration of 11.3 mU/L versus breastfed infants who at that age may have a plasma insulin concentration of 8.1±3.5 mU/L (p<0.001).

Insulin is a hormone secreted by the beta-cells of the pancreas in response to the ingestion of a meal. Insulin is central to regulating carbohydrate and fat metabolism in the body.

A high insulinogenic nutrition promotes a chronic stimulus to the beta-cells so that an adaptive hypertrophy and a progressive dys-regulation of the cells are induced. This results in postprandial hyperinsulinemia, i.e. excess levels of insulin circulating in the blood relative to the level of glucose. In other words, it is known that infants who are fed with infant formulas have a higher concentration of insulin than breast fed infants.

It is a problem with known infant formulas that they result in an increased production of insulin in the infant, since increased insulin production is connected to promoting weight gain, fat deposition, development of insulin resistance and glucose intolerance, metabolic syndrome and/or diabetes.

Hence, there is an unmet need for an infant formula which when fed to an infant will result in insulin levels in the infant which is more similar to the insulin level of a breastfed infant, or which will result in insulin levels in the infant which is lower than the levels found in an infant fed with conventional infant formulas found on the market.

### SUMMARY OF THE INVENTION

Thus, an object of the present invention is to provide a nutritional composition such as an infant formula, which results in lower insulin production than conventional nutritional compositions found on the market today, and thus reduce the risk of developing metabolic syndrome, obesity, glucose intolerance or diabetes mellitus later in life.

In particular, it is an object of the present invention to provide a nutritional composition such as an infant formula that solves the above mentioned problems of the prior art associated with a high insulin production which may cause increased weight gain, increased fat deposition, increased risk of develop obesity, increased risk of develop metabolic syndrome, insulin resistance, glucose intolerance and diabetes.

While obesity in childhood and adolescence is increasing to the point where it is starting to be of serious concern to healthcare professionals, there are many contributing factors to obesity, including nutritional, environmental and inherited factors. It is recognized that the likelihood of developing a nutritional product which is effective in reducing the risk of developing obesity in the infant population is still remote.

However, without being bound by any theory the inventors of the present invention believe that it is possible to reduce the risk of metabolic syndrome later in life, obesity, glucose intolerance or further diabetes mellitus by feeding an infant with a nutritional composition such as an infant formula according to the invention. The infant will usually be fed with the nutritional composition from birth or from 2-4 weeks after birth.

The inventors of the present invention have surprisingly found that infants fed with an infant formula comprising a high amount of phospholipids will obtain a lower C-peptide level as compared to an infant fed with a standard infant formula having a low amount of phospholipids.

Further, the inventors of the present invention have surprisingly found that an infant formula comprising a high amount of phospholipids in combination with bioactive compounds provides a synergistic effect with regard to the C-peptide level in infants fed with said infant formula as compared to infants fed with a standard infant formula having a low amount of phospholipids.

C-peptide is a protein that is secreted along with insulin from pancreatic beta-cells. Insulin secretion cannot itself be directly calculated from insulin peripheral concentrations due to the large and variable hepatic extraction of the hormone. Therefore, C-peptide concentrations are commonly used as a semi-quantitative marker of insulin secretion in a variety of clinical situations.

Thus, one aspect of the invention relates to a nutritional composition—such as an infant formula—comprising phospholipid in an amount of at least 300 mg/L.

Another aspect of the present invention relates to said nutritional composition for use in administration to an infant so as to obtain a lower C-peptide level in the infant as compared to the C-peptide level in an infant fed with a standard nutritional composition.

Yet another aspect of the present invention relates to said nutritional composition for use in administration to an infant so as to obtain an insulin secretion in the infant approximating the insulin secretion in breast fed infants.

Still another aspect of the present invention relates to said nutritional composition for use in administration to an infant so as to reduce the risk of developing metabolic syndrome, increased weight gain, increased fat deposition, overweight, obesity, insulin resistance, glucose intolerance, or diabetes mellitus later in said infant's life.

The present invention will now be described in more details.

### DETAILED DESCRIPTION OF THE INVENTION

Definitions:

Prior to discussing the present invention in further details, the following terms and conventions will first be defined:

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth. All references to singular characteristics or limitations of the present invention shall include the corresponding plural characteristic or limitation, and vice versa, unless otherwise specified or clearly implied to the contrary by the context in which the reference is made.

In the context of the present invention, the term “ratio” by weight (weight/weight) refers to the ratio between the weights of the mentioned compounds. For example, a mixture comprising 60 g whey and 40 g casein would have a weight ratio which is equal to 60:40, which is equal to 3:2 or 1.5 (that is 3 divided with 2). Similarly, a mixture of 50 g whey and 50 g casein would have a ratio by weight of whey and casein of 50:50, which is equal to 1:1 or 1 (that is 1 divided with 1).

The term “and/or” used in the context of the “X and/or Y” should be interpreted as “X”, or “Y”, or “X and Y”.

Unless defined otherwise, all technical and scientific terms used herein have the same meaning as commonly understood by one of ordinary skill in the art.

The term “infant” will in the context of the present invention mean a child under the age of 2 years, preferably the infant is a child under the age of 12 months, such as under the age of 9 months, particularly under the age of 6 months.

In the context of the present invention, the infant may be any term infant or preterm infant. In an embodiment of the invention the infant is selected from the group of preterm infants and term infants.

The expression “nutritional composition” means a composition which nourishes a subject. This nutritional composition is usually to be taken orally or intravenously, and it usually includes a lipid or fat source and a protein source.

In the context of the present invention, the nutritional compositions are typically synthetic nutritional compositions, i.e. not of human origin (e.g. this is not breast milk). Some examples of nutritional compositions according to the invention are infant formulas, fortifiers (e.g. human milk fortifier) or supplements.

Advantageously the nutritional composition according to the invention is an infant formula. The nutritional compositions can be in powder or liquid form. In some embodiments of the invention, the nutritional composition is a hypoallergenic nutritional composition.

The expression “synthetic composition” means a mixture obtained by chemical and/or biological means, which can be chemically identical to the mixture naturally occurring in mammalian milks.

The expression “hypoallergenic nutritional composition” means a nutritional composition which is unlikely to cause allergic reactions.

The term “infant formula” as used herein refers to a nutritional composition intended for infants and as defined in Codex Alimentarius, (Codex STAN 72-1981) and Infant Specialities (incl. Food for Special Medical Purpose) as defined in Codex Alimentarius, (Codex STAN 72-1981). It also refers to a foodstuff intended for particular nutritional use by infants during the first months of life and satisfying by itself the nutritional requirements of this category of person (Article 2(c) of the European Commission Directive 91/321/EEC 2006/141/EC of 22 December 2006 on infant formulae and follow-on formulae). The infant formulas can encompass the starter infant formulas and the follow-up or follow-on formulas. Generally a starter formula is for infants from birth as breast-milk substitute, and a follow-up or follow-on formula from the 6th month onwards.

The expressions “later in life” or “later in said infant's life” refer in the context of the present invention to effects measured in the child after the age of 1 year of life, such as after the age of 2 years, preferably after the age of 4 years, such as after the age of 5 years, even more preferably after the age of 7 years of life and as a comparison to average observations for subjects of the same age, but not having the same conditions because fed with another nutrition.

Phospholipid:

In the context of the present invention, the term “phospholipid” refers to one or more phospholipids. The phospholipid may be any known phospholipid.

One aspect of the invention relates to a nutritional composition comprising phospholipid in an amount of at least 300 mg/L.

In some embodiments of the invention, phospholipids are present in an amount from 0.3 to 3 g/L, such as from 0.3 to 2 g/L, preferably from 0.35 to 1.8 g/L, such as from 0.4 to 1.6 g/L, such as from 0.42 to 1.4 g/L. In some embodiments, phospholipids are present in an amount from 0.4 to 1.2 g/L, or 0.4 to 1 g/L or 0.4 to 0.9 g/L, or 0.4 to 0.8 g/L or 0.4 to 0.7 g/L.

In some other embodiments of the invention, phospholipids are present in an amount from 0.4 to 3 g/L, such as from 0.5 to 2 g/L, preferably from 0.55 to 1.8 g/L, such as from 0.6 to 1.6 g/L, even more preferably from 0.62 to 1.4 g/L.

In an embodiment of the invention, the phospholipid is selected from the group of phosphatidyl choline, phosphatidyl ethanolamine, sphingomyelin, phosphatidyl inositol, phosphatidic acid, phosphatidyl serine and combinations thereof.

In a specifically advantageous embodiment of the invention, the phospholipid is a combination of phosphatidyl choline, phosphatidyl ethanolamine, sphingomyelin, phosphatidyl inositol, and phosphatidyl serine.

Phospholipid may be derived from various sources. The phospholipid source may be any source which is suitable for use in infant nutrition. Some sources rich in phospholipid include for example egg-yolk, lecithin from soya bean, oils, milk, etc.

Bioactive Compound:

In an embodiment of the present invention, the nutritional composition comprises one or more bioactive compounds in an amount (i.e. total amount) of at least 0.2 g/L.

In the context of the present invention, the term “bioactive compound” is defined as a molecule which has interaction with or an effect on any cell tissue in the human body, i.e. a molecule which has a physiological effect on the human body, and for example a molecule which has an effect on C-peptide levels on the human body. In the present invention, the expression “bioactive compound” can encompass a single or a mixture of bioactive compounds. In particular the term “bioactive compound” refers to compounds which are able to decrease the C-peptide level in a human being and even more particularly, the “bioactive compound” refers to compounds which have a synergistic effect with phospholipids in decreasing C-peptide levels in a human being.

Examples of bioactive compounds are immunoglobulins, lactoferrin, gangliosides, sialic acid, growth factors, lactoperoxidase, lysozyme, cytokines, and nucleosides.

The nutritional composition of the present invention can comprise at least one bioactive compound. In an embodiment of the invention, the nutritional composition comprises at least 2 bioactive compounds, such as at least 3 bioactive compounds, or at least 4 bioactive compounds, or at least 5 bioactive compounds or even more.

In a particular embodiment of the present invention, the bioactive compound is selected from the group of immunoglobulins, lactoferrin, gangliosides, sialic acid and combinations thereof. For example the nutritional composition comprises at least immunoglobulins and one or more other bioactive compounds.

In another particular embodiment of the invention, the nutritional composition comprises one or more bioactive compound in an amount from 0.2 to 15 g/L, such as from 0.25 to 10 g/L, preferably from 0.3 to 7 g/L, even more preferably from 0.35 to 5 g/L, such as from 0.4 to 1.5 g/L.

The bioactive compound may also be present in the nutritional composition in an amount from 0.2 to 1.0 g/L, such as from 0.25 g/L to 0.8 g/L, or from 0.3 to 0.75 g/L, or from 0.35 to 0.7 g/L, such as from 0.4 to 0.65 g/L or such as 0.5 to 0.7 g/L.

According to the invention, the amount (and therefore the different above-mentioned ranges) of bioactive compound should be understood as the total amount of the bioactive compound(s). So for example the nutritional composition can comprise several bioactive compounds. In some embodiments, a part of the bioactive compounds or all of them is/are in an amount lower than 0.2 g/L (e.g. in an amount from 1 to 200 mg/L) but the total amount of bioactive compounds in the nutritional composition will fall under the above-mentioned ranges. Of course the invention also encompasses some embodiments where all the bioactive compounds are present in an amount (both the individual and the total amounts) higher than 0.2 g/L and also in amounts that can fall in the above-mentioned ranges.

In an embodiment of the invention, the bioactive compound comprises one or more immunoglobulin (Ig), such as IgA, IgD, IgE, IgG, and IgM. In an advantageous embodiment of the invention, the bioactive compound comprises IgG.

In a particular embodiment of the invention, immunoglobulin is present in the nutritional composition in an amount of from 50 to 500 mg/L, preferably from 100 to 400 mg/L, such as from 200 to 300 mg/L.

In another particular embodiment of the invention, the bioactive compound comprises gangliosides. The gangliosides present in the nutritional composition according to the present invention may be any known ganglioside. Gangliosides are molecules composed of a glycosphingolipid with one or more sialic acids (e.g. n-acetylneuraminic acid) linked on the sugar chain. There are more than 60 gangliosides and all of them may be used either alone or in combination in the nutritional composition of the present invention.

Examples of gangliosides are ganglioside monosialo (GMs), such as GM1, GM2, GM3, ganglioside disialo (GDs), such as GD1a, GD1b, GD2, GD3, or ganglioside trisialo (GTs), such as GT1a, GT1b, or ganglioside quartesialo (GQs), such as GQ1

In a particular embodiment of the invention, the nutritional composition comprises gangliosides in an amount from 5 to 50 mg/L, such as from 7 to 30 mg/L, preferably from 10 to 20 mg/L.

In another particular embodiment of the invention, the bioactive compound comprises lactoferrin. The nutritional composition comprises preferably lactoferrin in an amount of at least 1 mg/L, such as from 1 mg/L to 20 mg/L, preferably from 3 mg/L to 15 mg/L, even more preferably from 5 to 10 mg/L.

In still another particular embodiment of the invention, the bioactive compound comprises sialic acid. Preferably the nutritional composition comprises sialic acid in an amount of at least 150 mg/L, such as at least 175 mg/L, preferably at least 200 mg/L, such as at least 210 mg/L, even more preferably at least 225 mg/L. For example the nutritional composition comprises sialic acid in an amount from 150 to 600 mg/L, such as from 175 to 500 mg/L, preferably from 200 to 450 mg/L, such as from 225 to 400 mg/L. The nutritional composition may also comprise sialic acid in an amount of from 165 to 320 mg/L.

In a particular embodiment of the invention the one or more bioactive compound is a combination of immunoglobulin, lactoferrin, gangliosides and sialic acid.

In a specific embodiment of the invention the one or more bioactive compound is a combination of immunoglobulin, lactoferrin, gangliosides and sialic acid, where immunoglobulin is immunoglobulin G.

In another embodiment of the invention, the nutritional composition comprises:

phospholipid in an amount of of 300 mg/L to 3 g/L

lactoferrin in an amount of 1 to 20 mg/L

IgG in an amount of 50 to 500 mg/L

gangliosides in an amount of 5 to 50 mg/L, and

sialic acid in an amount of 150 to 600 mg/L.

Proteins:

In an embodiment of the invention, the nutritional composition further comprises protein in an amount of 1.4 to 4.0 g/100 kcal, preferably from 1.4 to 3.5 g/100 kcal, such as from 1.6 to 3.0 mg/100 kcal, or from 1.6 to 2.5 mg/100 kcal, or from 1.6 to 2.0 mg/100 kcal. In a preferred embodiment of the invention the nutritional composition comprises protein in an amount from 1.6 to 1.8 g/100 kcal.

In the context of the present invention, the term “protein” refers to one or more proteins, and to both proteins derived from a source of protein, peptides and free amino acids in general.

The detailed make-up of the protein source is not believed to be critical. However, it is preferred that the protein source is based on cow's milk proteins such as whey, casein and mixtures thereof. Furthermore, protein sources based on soy can be used. In an embodiment of the invention, the protein is selected from the group of hydrolysed proteins, milk proteins, animal proteins, vegetable proteins, cereal proteins, free amino acids or combinations thereof.

The milk protein is preferably whey protein, casein, or a lactose-free milk protein.

In an embodiment of the invention, the protein comprises whey and casein proteins. Preferably, the casein to whey ratio is in the range of 30:70 to 70:30, such as 40:60, in particular 45:55 to 50:60, preferably 40:60.

The whey protein may be a whey isolate, acid whey, sweet whey or sweet whey from which the caseino-glycomacropeptide has been removed (modified sweet whey). Preferably, the whey protein is modified sweet whey.

The protein(s) in the protein source may be intact or hydrolysed or a combination of intact and hydrolysed proteins.

The term “intact” means in the context of the present invention proteins where the molecular structure of the protein(s) is not altered according to the conventional meaning of intact proteins. By the term “intact” is meant that the main part of the proteins are intact, i.e. the molecular structure is not altered, for example at least 80% of the proteins are not altered, such as at least 85% of the proteins are not altered, preferably at least 90% of the proteins are not altered, even more preferably at least 95% of the proteins are not altered, such as at least 98% of the proteins are not altered. In a particular embodiment, 100% of the proteins are not altered.

The term “hydrolysed” means in the context of the present invention a protein which has been hydrolysed or broken down into its component peptides or amino acids.

In a specific embodiment of the invention, the protein is hydrolysed protein.

The proteins may be either fully or partially hydrolysed. In an embodiment of the invention at least 70% of the proteins are hydrolysed, preferably at least 80% of the proteins are hydrolysed, such as at least 85% of the proteins are hydrolysed, even more preferably at least 90% of the proteins are hydrolysed, such as at least 95% of the proteins are hydrolysed, particularly at least 98% of the proteins are hydrolysed. In a particular embodiment, 100% of the proteins are hydrolysed.

Hydrolysis of proteins may be achieved by many means, for example by prolonged boiling in a strong acid or a strong base, or by using an enzyme such as the pancreatic protease enzyme to stimulate the naturally occurring hydrolytic process.

The protein(s) present in the nutritional composition according to the present invention may also be derived from free amino acids, or a combination of free amino acids and a source of protein, such as whey and casein.

Carbohydrates:

The nutritional composition according to present invention may also comprise a source of carbohydrates. The composition may comprise one or more carbohydrate.

The preferred source of carbohydrate is lactose although other carbohydrates such as saccharose, maltodextrin, and/or starch may also be added. Preferably, the carbohydrate present in the nutritional composition according to the present invention is between 9 and 14 g/100kcal. The carbohydrate present in the nutritional composition is preferably lactose.

Lipids:

The nutritional composition of the present invention also contains a source of lipids. The lipid source may be any lipid or fat which is suitable for use in nutritional compositions to be fed to infants. Preferred fat sources include coconut oil, low erucic rapeseed oil (canola oil), soy lecithin, palm olein, and/or sunflower oil. The essential polyunsaturated fatty acids linoleic acid and alpha-linolenic acid may also be added, as well as small amounts of oils containing high quantities of preformed long chain polyunsaturated fatty acids, such as arachidonic acid and docosahexaenoic acid, e.g. fish oils or single cell oils. In total, the lipid content may be between 4.4 and 6 g/100 kcal. Preferably, the ratio of linoleic aid (C18:2n-6) to alpha-linoleic acid (C18:3n-3) in the lipid source is between 5:1 to 15:1, preferably 7:1 to 10:1, even more preferably 8:1,the ratio of arachidonic acid (C20:4n-6) to docosahexaenoic acid (C22:6n-3) in the lipid source is preferably between 2:1 and 1:1.

Vitamins and Minerals:

The nutritional composition may also contain all vitamins and minerals understood to be essential in the daily diet in nutritionally significant amounts. Minimum requirements have been established for certain vitamins and minerals. Examples of minerals, vitamins and other nutrients optionally present in the nutritional composition include vitamin A, vitamin B1, vitamin B2, vitamin B6, vitamin E, vitamin K, vitamin C, vitamin D, folic acid, inositol, niacin, biotin, pantothenic acid, choline, calcium, phosphor, iodine, iron, magnesium, copper, zinc, manganese, chloride, potassium, sodium, selenium, chromium, molybdenum, taurine, and L-carnitine. The minerals are usually added in salt form.

Other Components:

If necessary, the nutritional composition may contain emulsifiers and stabilizers such as lecithin, e.g. soy lecithin, monoglycerides, diglycerides or citric esters of mono- and di-glycerides, and the like. This is especially the case if the composition is provided in liquid form and particularly if the content of lipids is high.

The nutritional composition according to the present invention may optionally comprise other compounds which may also have a beneficial effect such as probiotics (like probiotic bacteria), fibres, lactoferrin, nucleotides, nucleosides, and the like in the amounts customarily found in nutritional compositions.

Strains of Lactobacillus are the most common bacteria employed as probiotics. However, other probiotic strains than Lactobacillus may be used in the present nutritional composition, for example Bifidobacterium and certain yeasts and bacilli.

The probiotic microorganisms most commonly used are principally bacteria and yeasts of the following genera: Lactobacillus spp., Streptococcus spp., Enterococcus spp., Bifidobacterium spp. and Saccharomyces spp.

In some particular embodiments, the probiotic is a probiotic bacterial strain. Probiotic bacteria are bacteria which have a beneficial effect on the intestinal system of humans and other animals.

In some specific embodiments, it is particularly Bifidobacteria and/or Lactobacilli. A probiotic is a microbial cell preparation or components of microbial cells with a beneficial effect on the health or well-being of the host. Suitable probiotic bacterial strains include Lactobacillus rhamnosus ATCC 53103 obtainable from Valio Oy of Finland under the trademark LGG, Lactobacillus rhamnosus CGMCC 1.3724, Lactobacillus paracasei CNCM 1-2116, Bifidobacterium lactis CNCM 1.3446 sold by inter alia by the Christian Hansen company of Denmark under the trademark Bb12 and Bifidobacterium longum ATCC BAA-999 sold by Morigana Milk Industry Co. Ltd. of japan under the trademark BB536. The amount of probiotic, if present, likewise preferably varies as a function of the age of the infant.

In an embodiment of the invention, the nutritional composition further includes a probiotic strain such as a probiotic bacterial strain in an amount of from 10⁶ to 10¹¹ cfu/g of composition (dry weight).

Since probiotic bacteria have a beneficial effect on the intestinal flora in a human being, also an infant, it is believed by the inventors of the present invention, without being bound by any theory, that probiotic bacteria in a nutritional composition in combination with a high amount of phospholipids provide a synergistic effect to reduce the risk of an infant fed with said nutritional composition to obtain obesity later in life. Probiotics enables a better utilization of nutrients while producing by-products that may have a physiological effect on digestion. The use of specific probiotics can therefore improve the uptake and beneficial effect of a diet having a high amount of phospholipids.

The nutritional composition may also contain a least one prebiotic in an amount of 0.3 to 10%. A prebiotic is a non-digestible food ingredient than beneficially affects the host by selectively stimulating the growth and/or activity of one or a limited number of bacteria in the colon, and thus improves host health. Such ingredients are non-digestible in the sense that they are not broken down and absorbed in the stomach or small intestine and thus pass intact to the colon where they are selectively fermented by the beneficial bacteria. Examples of prebiotics include certain oligosaccharides, such as fructooligosaccharides (FOS) and galactooligosaccharides (GOS). The prebiotics can also be a BMO (bovine's milk oligosaccharide) and/or a HMO (human milk oligosaccharide) such as N-acetylated oligosaccharides, sialylated oligosaccharides, fucosylated oligosaccharides and any mixtures thereof. A combination of prebiotics may be used such as 90% GOS with 10% short chain fructo-oligosaccharides such as the product sold under the trademark Raftilose® or 10% inulin such as to product sold under the trademark Raftiline®.

A particularly preferred prebiotic is a mixture of galacto-oligosaccharide(s), N-acetylated oligosaccharide(s) and sialylated oligosaccharide(s) in which the N-acetylated oligosaccharide(s) represent(s) 0.5 to 4.0% of the oligosaccharide mixture, the galacto-oligosaccharide(s) represent(s) 92.0 to 98.5% of the oligosaccharide mixture and the sialylated oligosaccharide(s) represent(s) 1.0 to 4.0% of the oligosaccharide mixture. This mixture is hereinafter referred to as “CMOS-GOS”. Preferably, a composition for use according to the invention contains from 2.5 to 15.0 wt % CMOS-GOS on a dry matter basis with the proviso that the composition comprises at least 0.02 wt % of an N-acetylated oligosaccharide, at least 2.0 wt % of a galacto-oligosaccharide and at least 0.04 wt % of a sialylated oligosaccharide.

WO2006087391 and WO2012160080 provide some examples of production of CMOS-GOS.

“N-acetylated oligosaccharide” means an oligosaccharide having an N-acetyl residue.

Suitable N-acetylated oligosaccharides include GalNAcα1,3Galβ1,4Glc and Galβ1, 6GalNAcβ1,3Galβ1,4Glc. The N-acetylated oligosaccharides may be prepared by the action of glucosaminidase and/or galactosaminidase on N-acetyl-glucose and/or N-acetyl galactose. Equally, N-acetyl-galactosyl transferases and/or N-acetyl-glycosyl transferases may be used for this purpose. The N-acetylated oligosaccharides may also be produced by fermentation technology using respective enzymes (recombinant or natural) and/or microbial fermentation. In the latter case the microbes may either express their natural enzymes and substrates or may be engineered to produce respective substrates and enzymes. Single microbial cultures or mixed cultures may be used. N-acetylated oligosaccharide formation can be initiated by acceptor substrates starting from any degree of polymerisation (DP) from DP=1 onwards. Another option is the chemical conversion of keto-hexoses (e.g. fructose) either free or bound to an oligosaccharide (e.g. lactulose) into N-acetylhexosamine or an N-acetylhexosamine containing oligosaccharide as described in Wrodnigg, T. M.; Stutz, A. E. (1999) Angew. Chem. Int. Ed. 38:827-828.

“galacto-oligosaccharide” means an oligosaccharide comprising two or more galactose molecules which has no charge and no N-acetyl residue

Suitable galacto-oligosaccharides include Galβ1,6Gal, Galβ1,6Galβ1,4Glc Galβ1,6Galβ1,6Glc, Galβ1,3Galβ1,3Glc, Galβ1,3Galβ1,4Glc, Galβ1,6Galβ1,6Galβ1,4Glc, Galβ1,6Galβ1,3Galβ1,4Glc Galβ1,3Galβ1,6Galβ1,4Glc, Galβ1,3Galβ1,3Galβ1,4Glc, Galβ1,4Galβ1,4Glc and Galβ1,4Galβ1,4Galβ1,4Glc. Synthesised galacto-oligosaccharides such as Galβ1,6Galβ1,4Glc Galβ1,6Galβ1,6Glc, Galβ1,3Galβ1,4Glc, Galβ1,6Galβ1,6Galβ1,4Glc, Galβ1,6Galβ1,3Galβ1,4Glc and Galβ1,3Galβ1,6Galβ1,4Glc, Galβ1,4Galβ1,4Glc and Galβ1,4Galβ1,4Galβ1,4Glc and mixtures thereof are commercially available under the trademarks Vivinal ® and Elix'or ®. Other suppliers of oligosaccharides are Dextra Laboratories, Sigma-Aldrich Chemie GmbH and Kyowa Hakko Kogyo Co., Ltd. Alternatively, specific glycoslytransferases, such as galactosyltransferases may be used to produce neutral oligosaccharides.

“sialylated oligosaccharide” means an oligosaccharide having a sialic acid residue with associated charge.

Suitable sialylated oligosaccharides include NeuAcα2,3Galβ1,4Glc and NeuAcβ2,6Galβ1,4Glc. These sialylated oligosaccharides may be isolated by chromatographic or filtration technology from a natural source such as animal milks. Alternatively, they may also be produced by biotechnology using specific sialyltransferases either by enzyme based fermentation technology (recombinant or natural enzymes) or by microbial fermentation technology. In the latter case microbes may either express their natural enzymes and substrates or may be engineered to produce respective substrates and enzymes. Single microbial cultures or mixed cultures may be used. Sialyl-oligosaccharide formation can be initiated by acceptor substrates starting from any degree of polymerisation (DP) from DP=1 onwards.

Preparation:

The nutritional composition of the present invention may be prepared by any known or otherwise suitable manner. For example, a source of protein may be mixed together with a carbohydrate source and a lipid source in appropriate proportions. If used, emulsifiers may be included at this stage. Vitamins and minerals may be added at this stage, but may also be added later. Water, preferably water which has been subjected to reverse osmosis, may then be mixed in to form a liquid mixture. The temperature of mixing is preferably room temperature, but may also be higher. The liquid mixture may then be thermally treated to reduce bacterial loads. For example, the liquid mixture may be heated to a temperature from 75 to 130° C. for about 5 seconds to about 5 minutes. The mixture may then be cooled, and a pasteurized source of phospholipid may be added and further homogenized. In some cases, a source of phospholipid may also be added at an earlier stage, before heat treatment.

If it is desired to produce a powdered composition, the homogenised mixture is dried in a suitable drying apparatus, such as a spray drier or freeze drier and converted into powder.

If it is desired to produce a liquid nutritional composition, the homogenised mixture is filled into suitable containers, preferably aseptically. However, the liquid composition may also be retorted in the container, suitable apparatus for carrying out the filling and retorting of this nature is commercially available.

Uses of the Nutritional Composition:

The present invention is also directed to the nutritional composition according to the present invention for use in administration to an infant so as to obtain a lower C-peptide level in the infant as compared to the C-peptide level in an infant fed with a standard nutritional composition. The nutritional composition is administered to the infant by feeding the infant.

In the context of the present invention, a standard nutritional composition refers to a nutritional composition comprising carbohydrates, lipids, proteins, vitamins, minerals in amounts normally required for infants to obtain a suitable growth and wherein said standard nutritional composition comprises phospholipids in an amount below 260 mg/L, preferably below 250 mg/L, such as below 240 mg/I and even more preferably below 225 mg/L.

Advantageously, the nutritional composition according to the present invention is used in administration to an infant so as to obtain a C-peptide level (serum C-peptide level) measured in the infants fed with the nutritional composition below 2.2 ng/ml, such as below, 2.1 ng/ml, preferably below 2.0 ng/ml.

The infants referred to nutritional composition fed infants, which exhibit a higher C-peptide level than breast fed infants. In an embodiment of the invention, the infants are infants exhibiting a higher than normal C-peptide level and/or a higher than optimal C-peptide level, i.e. higher C-peptide level than in breast fed infants.

C-peptide level was measured in blood samples taken from infant by any conventional method.

Further, the present invention is directed to the nutritional composition according to the present invention for use in administration to an infant so as to obtain an insulin secretion in the infant approximating the insulin secretion in breast fed infants.

In a particular embodiment of the invention, the insulin concentration measured in the infants fed with the nutritional composition according to the present invention are below 10.5 mU/mL, such as below 10.0 mU/mL, preferably below 9.5 mU/mL, even more preferably below 9.0 mU/mL.

The infants referred to above are nutritional composition fed infants, which exhibit an insulinic level in blood higher than that in breast fed infants. In an embodiment of the invention, the infants are infants exhibiting a higher than normal insulinic level, i.e. higher insulinic level than in breast fed infants.

The present invention is also directed to the nutritional composition according to the present invention for use in administration to an infant so as to reduce the risk of developing hyperinsulinemia and/or its insulin secretion and/or to reduce the risk of developing diseases associated thereof in said infant.

The present invention is also directed to the nutritional composition according to the present invention for use in administration to an infant so as to reduce the risk of developing metabolic syndrome, increased weight gain, increased fat deposition, overweight, obesity, insulin resistance, glucose intolerance and/or diabetes mellitus later in said infant's life.

In a particular embodiment of the invention as described above, the infant is an infant genetically susceptible to develop metabolic syndrome, increased weight gain, overweight, obesity, insulin resistance, glucose intolerance and/or diabetes mellitus.

It is well known in the art that a nutrition that promotes insulin secretion will lead to hyperinsulinemia which promotes weight gain, increased fat deposition, obesity, diabetes and development of insulin resistance and metabolic syndrome, see for example Kopp, W. “High-Insulinogenic Nutrition—An Etiologic Factor for Obesity and the Metabolic Syndrome”, Metabolism, vol. 52, N0 7, 2003, page 840-844; Melnik, B. C. “Permanent impairment of insulin resistance from pregnancy to adulthood: The primary basic risk factor of chronic Western diseases, Medical Hypotheses, 2009.

Further, C-peptide levels are known to have an impact on insulin resistance, see Pollak et al., “Insulin resistance, estimated by serum C-peptide level, is associated with reduced event-free survival for postmenopausal women in NCIC CTG MA.14 adjuvant breast cancer trial”, Journal of Clinical Oncology, 2006, vol. 24, No. 185, page 524 and Bruemmer, D., “C-peptide in Insulin Resistance and Vascular Complications”, Circ. Res. 2006, vol. 24, 99(11); pages 1149-1151.

In a further aspect, the present invention relates to the use of a composition comprising at least 300 mg/L phospholipid for the preparation of a nutritional composition for use in obtaining a C-peptide level in an infant fed with the nutritional composition which is lower than the C-peptide level in an infant fed with a standard nutritional composition.

In another aspect, the present invention relates to the use of a composition comprising at least 300 mg/L phospholipid for the preparation of a nutritional composition for use in obtaining an insulin secretion in an infant fed with the nutritional composition approximating the insulin secretion in breast fed infants.

The present invention is also directed to the use of a composition comprising at least 300 mg/L phospholipid for the preparation of a nutritional composition for use to reduce the risk of developing hyperinsulinemia and/or its insulin secretion and/or to reduce the risk of developing diseases associated thereof in an infant fed with the nutritional composition.

In still another aspect, the present invention relates to the use of a composition comprising at least 300 mg/L phospholipid for the preparation of a nutritional composition for use in reducing the risk of developing metabolic syndrome, increased weight gain, increased fat deposition, overweight, obesity, insulin resistance, glucose intolerance or diabetes mellitus in an infant fed with the nutritional composition.

In the context of the use of nutritional composition according to the present invention, the nutritional composition can be used to meet the infant's sole, primary or supplemental nutritional needs. For powder embodiments, the use of the nutritional composition also includes the step of reconstituting the powder with an aqueous vehicle, typically water, to form the desired caloric density, which is then orally or enterally fed to the infant to provide the desired nutrition. The powder is reconstituted with a quantity of water, or other suitable fluids such as human milk, to produce a volume suitable for about one feeding.

In a further aspect, the present invention relates to a method for obtaining a C-peptide level in an infant fed with the nutritional composition which is lower than the C-peptide level in an infant fed with a standard nutritional composition, said method comprising administering to said infant fed with the nutritional composition, a composition comprising at least 300 mg/L phospholipid.

In another aspect, the present invention relates to a method for obtaining an insulin secretion in an infant fed with the nutritional composition approximating the insulin secretion in breast fed infants, said method comprising administering to said infant fed with the nutritional composition, a composition comprising at least 300 mg/L phospholipid.

The present invention is also directed to a method for reducing the risk of developing hyperinsulinemia and/or its insulin secretion and/or to reduce the risk of developing diseases associated thereof in an infant fed with the nutritional composition, said method comprising administering to said infant a composition comprising at least 300 mg/L phospholipid.

In still another aspect, the present invention relates a method for reducing the risk of developing metabolic syndrome, increased weight gain, increased fat deposition, overweight, obesity, insulin resistance, glucose intolerance or diabetes mellitus in an infant fed with the nutritional composition.

It should be noted that embodiments and features described in the context of one of the aspects of the present invention also apply to the other aspects of the invention.

All patent and non-patent references cited in the present application, are hereby incorporated by reference in their entirety.

The invention will now be described in further details in the following non-limiting examples.

### EXAMPLES

The following examples illustrate specific embodiments of the nutritional composition of the present invention, including the use of the nutritional composition in feeding infants for reducing the amount of C-peptide in said infants as compared to infants fed with conventional nutritional compositions. The examples are given solely for the purpose of illustration and are not to be construed as limitations of the present invention, as many variations thereof are possible without departing from the spirit of the invention.

### Example 1

The following example illustrates the composition of a conventional standard infant formula, see table 1 below.

TABLE 1

| Nutrient | Per 100 kcal |
|---|---|
| Energy (kcal) | 100 |
| Fat in total (g) | 5.34 |
| milk fat (g) | 0.15 |
| non-milk fat (g) | 5.18 |
| linoleic acid (g) | 0.77 |
| linolenic acid (mg) | 95 |
| Phospholipids (mg) | 24.07 |
| Protein (g) | 1.85 |
| Carbohydrates (g) | 11.14 |
| lactose (g) | 10.60 |
| Minerals in total (g) | 0.37 |
| Sodium (mg) | 39.0 |
| Potassium (mg) | 85.0 |
| Chloride (mg) | 64.0 |
| Calcium (mg) | 64.0 |
| Phosphorous (mg) | 32.0 |
| Magnesium (mg) | 7.7 |
| Manganese (μg) | 6.0 |
| Selenium (μg) | 1.7 |
| Vitamins | |
| Vitamin A(μg) | 104.0 |
| Vitamin D (μg) | 1.50 |
| Vitamin E (mg) | 1.10 |
| Vitamin K (μg) | 9.60 |
| Vitamin C (mg) | 12.90 |
| Vitamin B1 (mg) | 0.07 |
| Vitamin B2 (mg) | 0.16 |
| Niacin (mg) | 1.00 |
| Vitamin B6 (mg) | 0.10 |
| Folic acid (μg) | 12.00 |
| Pantothenic acid (mg) | 0.50 |
| Vitamin B12 (μg) | 0.38 |
| Biotin (μg) | 2.10 |
| Choline (mg) | 7.70 |
| Inositol (mg) | 4.00 |
| Taurine (mg) | 8.10 |
| Carnitine (mg) | 1.60 |
| Minerals | |
| Iron (mg) | 1.10 |
| Iodine (μg) | 16.0 |
| Copper (mg) | 0.05 |
| Zinc (mg) | 0.67 |

The distribution of various phospholipids in the above standard infant formula is given in table 2 below.

TABLE 2

| Phospholipid | Content (mg/L infant formula) |
|---|---|
| Phosphatidylcholine | 60 |
| Phosphatidylethanolamine | 48 |
| Sphingomyelin | 58 |
| Phosphatidylinositol | 22 |
| Phosphatidylserine | 26 |
| Total content of phospholipids | 220 |

### Example 2

The following example illustrates an infant formula comprising a high amount of phospholipids according to the present invention, test infant formula 1. See table 3 below.

TABLE 3

| Nutrient | Per 100 kcal |
|---|---|
| Energy (kcal) | 100 |
| Fat in total (g) | 5.34 |
| milk fat (g) | 0.23 |
| non-milk fat (g) | 5.11 |
| linoleic acid (g) | 0.77 |
| linolenic acid (mg) | 95 |
| Phospholipids (mg) | 94.20 |
| Protein (g) | 1.85 |
| Carbohydrates (g) | 11.14 |
| lactose (g) | 10.60 |
| Minerals in total (g) | 0.37 |
| Sodium (mg) | 40.0 |
| Potassium (mg) | 85.0 |
| Chloride (mg) | 64.0 |
| Calcium (mg) | 64.0 |
| Phosphorous (mg) | 32.0 |
| Magnesium (mg) | 7.7 |
| Manganese (μg) | 7.0 |
| Selenium (μg) | 1.5 |
| Vitamins | |
| Vitamin A(μg) | 104.0 |
| Vitamin D (μg) | 1.50 |
| Vitamin E (mg) | 1.10 |
| Vitamin K (μg) | 9.60 |
| Vitamin C (mg) | 12.90 |
| Vitamin B1 (mg) | 0.07 |
| Vitamin B2 (mg) | 0.16 |
| Niacin (mg) | 1.00 |
| Vitamin B6 (mg) | 0.10 |
| Folic acid (μg) | 12.00 |
| Pantothenic acid (mg) | 0.50 |
| Vitamin B12 (μg) | 0.38 |
| Biotin (μg) | 2.10 |
| Choline (mg) | 7.70 |
| Inositol (mg) | 4.00 |
| Taurine (mg) | 8.10 |
| Carnitine (mg) | 1.60 |
| Minerals | |
| Iron (mg) | 1.10 |
| Iodine (μg) | 16.0 |
| Copper (mg) | 0.05 |
| Zinc (mg) | 0.67 |

The distribution of various phospholipids in the above test infant formula 1 is given in table 4 below.

TABLE 4

| Phospholipid | Content (mg/L infant formula) |
|---|---|
| Phosphatidylcholine | 173 |
| Phosphatidylethanolamine | 187 |
| Sphingomyelin | 141 |
| Phosphatidylinositol | 57 |
| Phosphatidylserine | 80 |
| Total content of Phospholipids | 647 |

The infant formula disclosed in this example is manufactured by mixing 98% by weight of a standard infant formula as disclosed in example 1, with a 2% by weight of BPC 60 (buttermilk protein concentrate) preparation comprising 18.7% (wt/wt) of phospholipids, see the following table 5 for the composition of BPC 60.

TABLE 5

| Component (% wt/wt) | BPC 60 |
|---|---|
| Protein | 59.4 |
| Lactose | 10.9 |
| Fat | 23.7 |
| Ash | 5.9 |
| Moisture | 3.5 |
| Total phospholipid | 18.7 |
| Phosphatidylcholine | 4.9 |
| Phosphatidylinositol | 1.5 |
| Phosphatidylserine | 2.1 |
| Phosphatidylethanolamine | 5.4 |
| Sphingomyelin | 4.5 |

The standard infant formula ingredients were mixed with water (subjected to reverse osmosis) at 20° C. in a tank. The liquid mixture was further thermally treated at a temperature of 105° C. for 5 seconds. Then the mixture was cooled, and pasteurised BPC 60 (at 75° C. for 15 seconds) was added and homogenised.

### Example 3

The following example illustrates an infant formula comprising a high amount of phospholipids and bioactive compounds, test infant formula 2. See table 6 below.

TABLE 6

| Nutrient | Per 100 kcal |
|---|---|
| Energy (kcal) | 100 |
| Fat in total (g) | 5.34 |
| milk fat (g) | 0.23 |
| non-milk fat (g) | 5.11 |
| linoleic acid (g) | 0.77 |
| linolenic acid (mg) | 95 |
| Phospholipids (mg) | 74.17 |
| Protein (g) | 1.85 |
| Carbohydrates (g) | 11.14 |
| lactose (g) | 10.60 |
| Minerals in total (g) | 0.37 |
| Sodium (mg) | 40.0 |
| Potassium (mg) | 85.0 |
| Chloride (mg) | 64.0 |
| Calcium (mg) | 64.0 |
| Phosphorous (mg) | 32.0 |
| Magnesium (mg) | 7.7 |
| Manganese (μg) | 7.0 |
| Selenium (μg) | 1.5 |
| Vitamins | |
| Vitamin A(μg) | 104.0 |
| Vitamin D (μg) | 1.50 |
| Vitamin E (mg) | 1.10 |
| Vitamin K (μg) | 9.60 |
| Vitamin C (mg) | 12.90 |
| Vitamin B1 (mg) | 0.07 |
| Vitamin B2 (mg) | 0.16 |
| Niacin (mg) | 1.00 |
| Vitamin B6 (mg) | 0.10 |
| Folic acid (μg) | 12.00 |
| Pantothenic acid (mg) | 0.50 |
| Vitamin B12 (μg) | 0.38 |
| Biotin (μg) | 2.10 |
| Choline (mg) | 7.70 |
| Inositol (mg) | 4.00 |
| Taurine (mg) | 8.10 |
| Carnitine (mg) | 1.60 |
| Minerals | |
| Iron (mg) | 1.10 |
| Iodine (μg) | 16.0 |
| Copper (mg) | 0.05 |
| Zinc (mg) | 0.67 |

The distribution of various phospholipids in the above test infant formula 2 is given in table 7 below.

TABLE 7

| Phospholipid | Content (mg/L infant formula) |
|---|---|
| Phosphatidylcholine | 120 |
| Phosphatidylethanolamine | 127 |
| Sphingomyelin | 106 |
| Phosphatidylinositol | 41 |
| Phosphatidylserine | 58 |
| Total content of phospholipids | 452 |

The infant formula disclosed in this example is manufactured by mixing 96% by weight of a standard infant formula as disclosed in example 1 with a 4% by weight of a MFGM 10 preparation (MGFM refers to milk fat globule membrane) comprising about 7% (wt/wt) of phospholipids, and about 7.35% (wt/wt) of bioactive compounds, see the following table 8 for the composition of MFGM 10.

TABLE 8

| Component (% wt/wt) | MFGM 10 |
|---|---|
| Protein | 73 ± 3 |
| Lactose | 3 |
| Total lipids | 16 ± 2 |
| Total phospholipid | 7 ± 1 |
| IgG | 5 |
| Gangliosides | 0.2 |
| Sialic acid | 2 |
| Lactoferrin (native) | 0.15 |

The standard infant formula ingredients were mixed with water (subjected to reverse osmosis) at 20° C. in a tank. The liquid mixture was further thermally treated at a temperature of 105° C. for 5 seconds. Then the mixture was cooled, and the pasteurised MFGM 10 (at 75° C. for 15 seconds) was added and homogenised.

### Example 4

The amount of phospholipids and bioactive compounds in the standard infant formula (example 1), test infant formula 1 (example 2), test infant formula 2 (example 3) and those reported in human breast milk are given in the below table 9.

TABLE 9

| | Standard | Test | Test | | | | | | |
|---|---|---|---|---|---|---|---|---|---|
| | formula | formula 1 | formula 2 | Human breast milk¹ | | | Human breast milk² | | |
| | (example 1) | (example 2) | (example 3) | Min. | Max. | Mean | Min. | Max | Mean |
| Phospholipids | | | | | | | | | |
| (PL) (mg/L) | | | | | | | | | |
| Phosphatidylcholine | 60 | 173 | 120 | 25 | 96 | 60 | 25 | 115 | 70 |
| Phosphatidylethanolamine | 48 | 187 | 127 | 20 | 93 | 61 | 20 | 80 | 50 |
| Sphingomyelin | 58 | 141 | 106 | 40 | 139 | 80 | 35 | 145 | 90 |
| Phosphatidylinositol | 22 | 57 | 41 | 6 | 16 | 10 | 10 | 30 | 20 |
| Phosphatidylserine | 26 | 80 | 58 | 3 | 12 | 9 | 10 | 30 | 20 |
| Total content PL | 220 | 647 | 452 | 94 | 327 | 212 | 100 | 400 | 250 |

| | | | | | |
|---|---|---|---|---|---|
| Bioactive | | | | — | |
| compounds (g/L) | | | | | |
| Lactoferrin (g/L) | <Detection limit³ | <Detection limit³ | increase > 7.7 mg/L | — | 3.53-5.1 (~1 week) |
| | (7.8 ng/ml) | (7.8 ng/ml) | (increase > 0.006%) | | 1.9-2.9 (~1 month) |
| | | | | | 0.8-1.39 (~3-4 months) |
| IgG (mg/L) | 0.6-6.4⁴ | 0.6-6.4⁴ | increase > 258 mg/L | — | 32-27 (0-6.5 months) |
| | | | (increase > 0.2%) | | |
| Gangliosides | 1.16-3.87⁵ | 1.16-3.87⁵ | increase > 10.32 mg/L | — | 2.2-9.1 (~1 week) |
| (mg/L) | | | (increase > 0.008%) | | 0.8-9.0 (~1 month) |
| Sialic acid (g/L) | 0.12-0.2⁶ | 0.12-0.2⁶ | increase > 103.2 mg/L | — | 1.28-1.55 (~1 week) |
| | 0.07-0.13⁷ | 0.07-0.13⁷ | (increase > 0.08%) | | 0.53-0.61 (~1 month) |
| | | | | | 0.32 (~3-4 months) |

¹From Nestlé internal analytical data (trial performed in 2011-2012 in Singapore)
²Calculated based on literature reviews (Nestlé Research Centre - NRC, 21 Oct. 2010; NRC, 14 Dec. 2006; Lönnerdal, 2004).
³Calculated based on analytical results for a range of infant formulae
⁴Based on literature-reported values (Clyne & Kulczycki 1991)
⁵Calculated based on analytical results for a range of infant formulae & assuming 129 g powder reconstituted with 900 ml water.
⁶Calculated based on analytical results for a range of infant formulae & assuming 129 g powder reconstituted with 900 ml water (S. Austin, NRC).
⁷Calculated based on analytical results for a range of infant formulae & assuming 129 g powder reconstituted with 900 ml water (N. Sprenger, NRC)

From table 9 it is clear that the test formula 1 and 2 comprise more phospholipids than present in both a standard infant formula and in human breast milk. Further, table 9 shows that test formula 2 comprises a higher amount of bioactive compounds as compared to a standard infant formula.

### Example 5

The following example discloses a study of infants fed with three different infant formulas having different contents of phospholipids and bioactive compounds. The study has measured the C-peptide level in the infants fed with different infant formulas.

The three tested infant formulas were:

Standard infant formula as disclosed in example 1, which is a conventional infant formula comprising a low amount of phospholipid, whose level is representative for all conventional infant formulas on the market.

Test infant formula 1 as disclosed in example 2, which is an infant formula comprising the same amount of nutrients, i.e. fats, proteins, carbohydrates, vitamins and minerals, as in the standard infant formula (example 1), but contains a supplement of phospholipids.

Test infant formula 2 as disclosed in example 3, which is an infant formula comprising the same amount of nutrients, i.e. fats, proteins, carbohydrates, vitamins, and minerals, as in the standard infant formula (example 1), but contains a supplement of a composition comprising phospholipids and bioactive compounds.

Infants in the three test groups were fed with the infant formula of example 1, 2 or 3 from 0 to 14 days after birth as their sole feed and up to 4 months of life. After 112 days a blood sample was taken from the infant and the C-peptide level in blood were measured. The infants fed with the three different infant formulas were randomly selected and placed in a test group.

Table 10, below, shows the C-peptide level measured in infants fed with the three infant formulas, i.e. the standard infant formula, the test infant formula 1 and the test infant formula 2.

TABLE 10

| | | Standard | Test infant | Test infant | |
|---|---|---|---|---|---|
| | Summary | formula | formula 1 | formula 2 | p- |
| Test | Statistics | (example 1) | (example 2) | (example 3) | value |
| Subjects | Number of | 28 | 36 | 33 | |
| | infants | | | | |
| C-peptide | Mean | 2,358 | 1.997 | 1.836 | 0.025 |
| (ng/ml) | value | (0.8657) | (0.8508) | (0.9579) | |
| | (SD (*)) | | | | |

(*) SD: refers to standard deviation

As evident from the results of the study, infants fed with an infant formula comprising a high level of phospholipids will have a significantly lower amount of C-peptide in the blood in contrast to infants fed with a standard infant formula comprising low amounts of phospholipid.

Further, the study shows a significantly lower C-peptide level in blood samples of infants fed with an infant formula supplemented with a composition comprising a combination of phospholipids and bioactive compounds.

The study clearly shows that the phospholipids and the bioactive compounds act synergistically in decreasing the level of C-peptide in infants. Even though, test infant formula 2 has a lower amount of phospholipids than test infant formula 1, the C-peptide level in the infants fed with test infant formula 2 is lower than the C-peptide level measured in infants fed with test infant formula 1. This indicates a synergistic effect between phospholipids and bioactive compounds in test infant formula 2.

The results of this study were surprising. The study shows that phospholipids in an infant formula can decrease the level of C-peptide in an infant fed with the infant formulation. Further, the results of this study surprisingly showed that phospholipids and bioactive compounds have a synergistic effect in decreasing C-peptide levels in an infant.

The decreased C-peptide levels in the infants fed with either test infant formula 1 or test infant formula 2 indicates that insulin secretion in the infant is reduced, since C-peptide is a marker for insulin secretion. Thus, the insulin secretion of infants fed with an infant formula according to the present invention becomes closer to the one of a breast fed infant as compared to the insulin secretion in infants fed with a conventional standard infant formula.

The normal C-peptide level in infants and children is from 0.14 to 2.2 ng/ml. The C-peptide level has been described in several references, but not with a clear and unambiguous value. Below is the content of C-peptide in infants from different references shown:
Normal C-peptide levels is described to be from 0.5 to 2.0 ng/mL (nanograms per milliliter) (http://www.nlm.nih.gov/medlineplus/ency/article/003701.htm)
Normal maternal and cord CPR (C-peptide immunoreactivity levels, mean ±SEM, were 1.5±0.3 and 0.9±0.1 ng/ml, respectively (http://pediatrics.aappublications.org/content/53/6/923)
Babies from non-diabetic mothers=50-440 picomol/L=137.5-1210 ng/L=0.14-1.2 ng/mL (http://informahealthcare.com/doi/abs/10.3109/01443618109067429)
31 babies of the diabetic mothers were born with higher C-peptide (1.01±0.16 nmol/L=2.7 ng/mL) than babies of non-diabetic mothers (0.39±0.04 nmol/L=1 ng/mL) (http://www.springerlink.com/content/g75267275n21k411/)
http://www.diabeteshealth.com/read/2000/09/01/2020/interpreting-your-c-peptide-values/
   Children (<15 years old) 8:00 a.m. fasting: 0.4 to 2.2 ng/ml
   Adults 8:00 a.m. fasting: 0.4 to 2.1 ng/ml
   Two hours postprandial (after a meal): 1.2 to 3.4 ng/ml
   Two hours post glucose load: 2.0 to 4.5 ng/ml

The decrease in insulin secretion (decrease in C-peptide level) will have a beneficial effect on a wide range of adverse effects associated with high insulin secretion and insulin resistance, including obesity, diabetes mellitus, metabolic syndrome etc. Furthermore, high insulin secretion and insulin resistance are known to be linked with other potential adverse effects, such as cardiovascular, allergic and autoimmune, and neurodegerative diseases.

### Example 6

The following example discloses a study of infants fed with two different infant formulas, the two infant formulas being similar except for the content of protein, where formula A) has a protein content of 2.15 g/100 kcal and formula B) has a protein content of 1.61 g/100 kcal.

Infants in the two test groups (group A and group B) were fed with the infant formula A and B respectively from 3 months after birth as their sole feed. After 6 months from birth a blood sample was taken from the infant and the C-peptide level in the blood were measured. The infants in the two test groups were randomly selected and placed in a test group.

The difference in the C-peptide level between the two test groups were calculated Δ Group B-Group A=−18.86% (p-value 0.087)

Thus, the result showed that the C-peptide level in infants fed with an infant formula having a protein content of 2.15 g/100 kcal was higher than the C-peptide level in infants fed with an infant formula having a protein content of 1.61 g/100 kcal.

### Example 7

Another experiment was performed in similar conditions than for example 6. The difference in the C-peptide level between the two test groups were calculated Δ Group B-Group A=−18.43% (p-value 0.083). Similar conclusions could therefore be made.

1. A nutritional composition comprising phospholipid in an amount of at least 300 mg/L.

2. The nutritional composition according to claim 1, wherein the nutritional composition further comprises at least one bioactive compound in an amount of at least 0.2 g/L.

3. The nutritional composition according to claim 1, wherein the phospholipid is selected from the group consisting of phosphatidyl choline, phosphatidyl ethanolamine, sphingomyelin, phosphatidyl inositol, phosphatidic acid, phosphatidyl serine and combinations thereof.

4. The nutritional composition according to claim 1, wherein the bioactive compound is selected from the group consisting of immunoglobulins, lactoferrin, gangliosides, sialic acid, and combinations thereof.

5. The nutritional composition according to claim 1, wherein the nutritional composition comprises protein in an amount of 1.4 to 2.0 g/100 Kcal.

6. The nutritional composition according to claim 5, wherein the protein is selected from the group consisting of milk proteins, animal proteins, vegetable proteins, cereal proteins, free amino acids and combinations thereof.

7. The nutritional composition according to claim 6, wherein the milk protein is selected from the group consisting of casein, a whey protein and a lactose-free milk protein.

8. The nutritional composition according to claim 5, wherein the protein comprises whey protein and casein in the ratio of 60:40.

9. The nutritional composition according to claim 5, wherein the protein comprises fully or partially hydrolysed protein.

10. The nutritional composition according to claim 1, wherein the bioactive compound is a combination of immunoglobulin, lactoferrin, gangliosides and sialic acid.

11. The nutritional composition according to claim 1, wherein the nutritional composition comprises:
phospholipid in an amount of 300 mg/L to 3 g/L;
lactoferrin in an amount of 1 to 20 mg/L;
IgG in an amount of 50 to 500 mg/L;
gangliosides in an amount of 5 to 50 mg/L; and
sialic acid in an amount of 150 to 600 mg/L.

12. The nutritional composition according to claim 1 wherein it is an infant formula.

13. A method for obtaining a lower C-peptide level in an infant as compared to the C-peptide level in an infant fed with a standard nutritional composition comprising the step of administering to an infant in need of same a nutritional composition comprising phospholipid in an amount of at least 300 mg/L.

14. A method for obtaining an insulin secretion in an infant approximating the insulin secretion in a breast fed infant comprising the step of administering to an infant in need of same a nutritional composition comprising phospholipid in an amount of at least 300 mg/L.

15. A method for reducing the risk of developing metabolic syndrome, increased weight gain, increased fat deposition, overweight, obesity, insulin resistance, glucose intolerance and/or diabetes mellitus later in an infant's life comprising the step of administering to an infant in need of same a nutritional composition comprising phospholipid in an amount of at least 300 mg/L.

16. A method for reducing the risk of developing hyperinsulinemia and/or its insulin secretion and/or to reduce the risk of developing diseases associated thereof in an infant comprising the step of administering to an infant in need of same a nutritional composition comprising phospholipid in an amount of at least 300 mg/L.

17. (canceled)
